(19) United States
(12) Patent Application Publication
(10) Pub. No.: US 2009/0178668 A1
(43) Pub. Date: Jul. 16, 2009

(54) Central Receiver Solar Power Systems: Architecture And Controls Methods

(76) Inventor: Deepak Boggavarapu, San Carlos, CA (US)

Correspondence Address: WILSON SONSINI GOODRICH & ROSATI, 650 PAGE MILL ROAD, PALO ALTO, CA, 94304-1050, US

(21) Appl. No.: 12/271,824

(22) Filed: Nov. 14, 2008

Related U.S. Application Data
(60) Provisional application No. 61/003,227, filed on Nov. 14, 2007.
(60) Provisional application No. 61/197,238, filed on Oct. 25, 2008.

(51) Int. Cl. F24J 2/38; F24J 2/10; B23P 19/04; F24J 2/00

(52) U.S. Cl. 126/601; 126/684; 29/700; 126/714

(57) ABSTRACT

The invention provides systems and methods for integrating central receiver solar power systems with existing infrastructure to form multi-purpose structures. The invention also provides arranging heliostats to accommodate shadowing effects. Additionally, improved systems and methods for solar tracking are provided. Such improved solar tracking may enable the heliostats to more accurately reflect sunlight to a central receiver.

### CROSS-REFERENCE

This application claims the benefit of U.S. Provisional Application No. 61/003,227, filed Nov. 14, 2007, and U.S. Provisional Application No. 61/______, filed Oct. 25, 2008, which applications are incorporated herein by reference.

### BACKGROUND OF THE INVENTION

Solar energy can be collected and converted into other forms of energy. Photovoltaic devices convert the sun's energy directly to electrical energy, while solar thermal devices collect heat energy. Currently, a central receiver solar power system consists of an array of heliostat mounted mirrors that track the motion of the sun and focus light to a central point at the top of a tower. The pointing accuracy of the heliostat mirrors is a key parameter that affects the ultimate performance of the system and determines the concentration ratio the system can achieve. Ultimately this affects the maximum temperature that can be achieved at the receiver placed at the top of the tower in thermal systems; and affects the ultimate electric power conversion efficiency in photovoltaic (PV) systems. The better the tracking and focusing, the smaller the illumination spot size and the less PV material required, which impacts system cost and performance beneficially.

Typically, solar central receiver tower systems have been built as dedicated facilities on large scale (tens to hundreds of megawatts per tower have been built and proposed) away from population centers using solar thermal technology. Currently solar towers are massive structures that use up a lot of materials and that require large investments in infrastructure.

Thus, a need exists for improved pointing accuracy of heliostat mirrors, which may reduce a target solar receiver size. A further need exists for placement of solar receivers in a manner that reduces infrastructure costs.

### SUMMARY OF THE INVENTION

The invention provides architecture and control methods for central receiver solar power systems that enable solar receivers to be combined with other towers or structures. The invention also provides improved tracking methods that enable smaller receivers that can provide greater flexibility for combining solar receivers with various structures. Various aspects of the invention described herein may be applied to any of the particular applications set forth below or for other types of tracking or energy generation systems. The invention may be applied as a standalone system or method, or as part of an application, such as a multi-purpose power plant. It shall be understood that different aspects of the invention can be appreciated individually, collectively, or in combination with each other.

This invention describes systems and methods for integrating heliostat solar tower systems into existing infrastructure in accordance with one aspect of the invention. One or more solar receivers may be combined with any structures such as windmill towers, cellphone antenna towers, high tension electrical towers, tall buildings, other antenna towers, telephone poles, or any other structure that may support a solar receiver. The solar receivers may be photovoltaic (PV) receivers, such as concentrated photovoltaic (CPV) receivers, or may be thermal receivers, or any combination thereof.

Another aspect of the invention provides for arranging one or more heliostats in order to accommodate shadows that may arise from a structure supporting a solar receiver, and any shadows that may arise from any moving parts from the structure or surroundings. Heliostats may be arranged surrounding the structure such that the heliostats can track the motion of the sun such that the reflected light from the heliostats may be directed to a common focal point on the receiver, such that the receiver may receive an approximately constant amount of illumination over a short period of time.

One aspect of the invention provides for accurate methods for heliostats to track and direct sunlight. Such accurate tracking may enable greater flexibility for solar tower integration with other structures. Typically, measuring and controlling an array of mirrors for a desired focal light distribution has been a difficult and costly process. This invention provides methods to simplify this tracking and control process with low cost parts, and may thus enable widespread use of heliostat based solar power systems. This invention consists of multiple unique systems or methods that may be used individually or in various combinations to optimize field performance.

One example of such a tracking system or method may utilize one or more accelerometers to determine the tilt of a heliostat mirror. By determining a mirror's orientation and combining this information with the position of the sun as a function of time and location of the mirror, heliostats can accurately control the sunlight reflection to a desired location.

Another example of a system or method that improves solar tracking involves current balancing. A receiver may comprise multiple tiles that may include a plurality of solar cells. The tiles may be connected in series such that areas of the receiver that are likely to receive a similar amount of sunlight are connected such that the photocurrent from the tiles are matched. This may provide an improved energy extraction efficiency.

Another tracking system or method may be used to direct the reflected light from a heliostat mirror to a desired spot. A receiver may be able to determine illumination levels at spatially different portions of the receiver, and thereby determine whether the light from the heliostats are being directed to the center of the receiver to create a desired light distribution. An error signal may be generated when a desired light distribution is not being implemented. The mirrors may be moved in sequential order to determine the effects of each mirror, and may proceed through the mirrors until they are aligned.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a windmill with a solar receiver incorporated therein in accordance with one embodiment of the invention.

FIG. 2 shows an example of a tile of a receiver.

FIG. 3A shows a top view of a structure along with a field of heliostats at a first time.

FIG. 3B shows a top view of a structure along with a field of heliostats at a second time.

FIG. 3C shows a top view of a structure along with a field of heliostats at a third time.

FIG. 3D shows a top view of a structure with a moving part with a field of heliostats.

FIG. 4 shows sunlight reflecting from a mirror and directed to a receiver on a tower.

FIG. 5 shows an accelerometer mounted on a mirror with two different mirror tilt angles.

FIG. 6 shows an example of a response of an accelerometer to a change in orientation angle.

FIG. 7 shows a receiver panel with cells and a cross sectional intensity pattern.

FIG. 8 shows a receiver panel with cells and another example of a cross sectional intensity pattern.

FIG. 9 shows a receiver panel with optical detectors.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

I. Multi-Purpose Tower

One aspect of the invention provides that one or more solar receivers may be combined with any structures such as windmill towers, cellphone antenna towers, high tension electrical towers, tall buildings, other wireless communication towers, other antenna towers, telephone poles, or any other structure that may support a solar receiver. Such structures incorporating a solar receiver may be multi-purpose towers or structures. The solar receivers may be photovoltaic (PV) receivers (such as concentrated photovoltaic (CPV) receivers), or may be solar thermal receivers, or any combination thereof. In some embodiments, solar receivers may include an optics element, which may concentrate light.

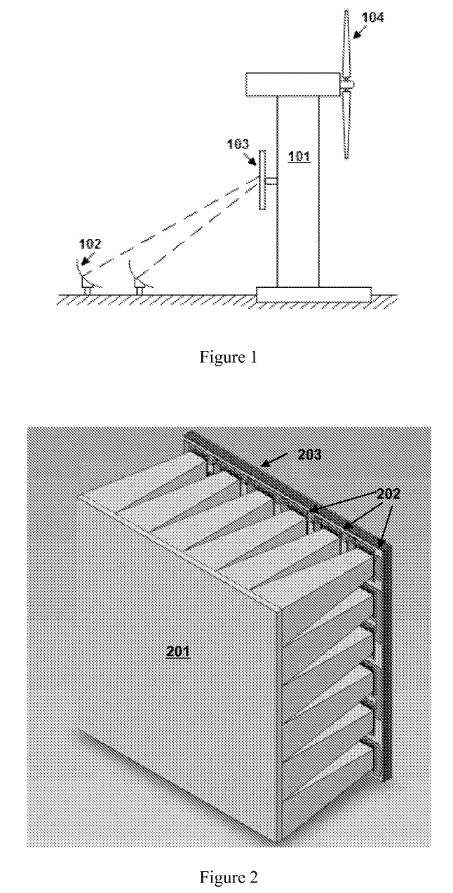

FIG. 1 shows a windmill tower 101 with a solar receiver incorporated therein in accordance with one embodiment of the invention. Any type of solar receiver, including but not limited to PV or solar thermal receivers may be used with a windmill. In a preferable embodiment of the invention, one or more heliostats 102 may direct sunlight to a CPV receiver 103 mounted on a windmill tower 101. Such a tower may be a multi-purpose wind-solar tower. A multi-purpose tower incorporating wind power and solar power may have various configurations. See e.g., U.S. Patent Application No. 2008/0258473, U.S. Pat. No. 7,162,833, U.S. Pat. No. 5,983,634,and U.S. Patent Application No. 2008/0150286, which are herein incorporated by reference in their entirety.

The receiver 103 may be mounted on any portion of the windmill. In some embodiments, the receiver may be mounted in a direction facing away from windmill blades 104, in other embodiments, the receiver may be mounted on the side of the tower with windmill blades. In some embodiments, the entire nacelle of the windmill may rotate so that the direction of windmill blades may change. In some embodiments, such as in areas with primarily unidirectional wind, the nacelle may be fixed in one direction and the windmill blade direction may not change. Multiple receivers may be mounted on a windmill or other structure and may have the same orientation, or may have different orientations. A receiver may also be mounted at any height along the windmill tower.

There may be several possible synergies for having a wind-solar multi-purpose structure. For example, for wind and solar, there may be common power conversion electronics and power connection systems from a wind-solar farm to a grid power connection. For example, a typical windmill may have an inverter that could convert variable frequency AC output of the turbine to DC and then back to line frequency, which in some embodiments may be 60 Hz AC. A solar inverter may convert DC to line frequency, which in some embodiments may be 60 Hz AC. In both cases, the second part of the inverter may be similar. In some embodiments, inverters may support both solar and wind applications in one unit. In addition to similar or shared power electronics, solar and wind systems may also share or leverage transformers, transmission systems, grid/connection and substations, and intra-site cabling.

The wind-solar system also has additional synergies that may arise from using a common tower to collect the wind and solar energies. Additionally, they may both utilize areas of surrounding land. The surrounding area may be permitted for renewable energy use, thus both systems can leverage an area that has been zoned for renewable energy use, or may use the same permits. Similarly, both systems can utilize surveying that has been done on the surrounding area. Also, any construction or grading and/or fencing structures may be leveraged by both systems.

A solar receiver may be combined with any other structure. Any of the embodiments herein may be adapted for non-concentrating PV applications, such as solar panels. Another example of a desirable structure may be a cellphone tower or any other type of wireless communication tower. The solar receiver may be a CPV receiver and the solar/cellphone tower may be surrounded by one or more heliostats directing sunlight to the CPV receiver. Alternatively, the receiver may be a solar thermal receiver. A multi-purpose solar-cellphone tower may enable communications as well as the generation of electrical energy or heat energy from the sun's energy.

There may be possible synergies from using a solar-cellphone tower. For example, cellphone towers may typically have a small backup battery plant and diesel generators for longer grid power outages. In a solar-cellphone system, a small battery plant can be used to eliminate some of the short term intermittency of a solar system (e.g., when a cloud passes by) without needing to buy a new battery system.

Previously used solar towers could be more than 300 feet in height and could require large construction effort at high cost. The invention may allow smaller scale tower systems to be used as well as the previous large towers. Small scale tower systems may comprise PV or thermal receivers that may be placed atop smaller towers (which may be on the order of <300 feet height). Alternatively, such receivers may be placed anywhere on the smaller towers. Such towers may fall within different ranges of heights—for example, a tower may be <50 feet tall, may be <100 feet tall, may be <150 feet tall, may be <200 feet tall, may be <250 feet tall, or may be <400 feet tall. Alternatively, receivers may be placed on large pre-existing structures, such as tall buildings.

The invention may allow for smaller receivers. For example, a receiver may weigh 300-500 pounds. A receiver may also be approximately a square meter in area. In some embodiments, the receiver area may be less than a square meter, or may be less than half a square meter, or may be less than a quarter square meter. In some embodiments of the invention, larger receivers may be used, such as those with an area greater than a square meter in area.

Many tower structures/elevated structures already exist in modern infrastructure close to population and/or load centers. Some towers may be located in non-populous regions with open space or land surrounding them. Such open surrounding areas may provide space for mirrors to be mounted to direct sunlight to the towers. Many hundreds of thousands of pre-existing structures may already be installed worldwide. The invention provides the use of an existing structure to hold a central receiver of a solar power system. For instance, such an existing structure may be retrofitted with a solar receiver that may be added to the existing structure. It may be beneficial to integrate solar power systems with an existing structure, such that more power may be generated at a lower cost. In some embodiments, new multi-purpose structures may be built, which may still reduce infrastructure costs compared to building two separate structures.

A structure may be used for multiple purposes and may lower the cost of solar power systems. For instance, a tower may have been built originally for one purpose only (e.g., cell phone tower, wind tower, electric utility towers, high tension electrical tower, etc.) but can now be used for more than one purpose. This may be made more practicable by the use of a higher efficiency, lightweight receiver Traditional solar tower systems did not allow for the use of smaller structures with solar receivers due to the large size and weight of the receiver. Larger receivers were often used due to inaccurate heliostat trackers. Smaller scale photovoltaic and thermal receivers can be mounted within the structural limitations imposed by existing towers/structures. Such receivers may have a smaller size and weight. Additionally, existing towers/structures may have different/lower structural stability specifications than dedicated solar power towers. Thus, pointing and tracking accuracy of a mirror field may be held to tighter tolerances or may be adjusted more frequently in order to enable the user of smaller receivers. Further systems and methods for improved tracking are discussed at greater length below.

Thus, the existing tower infrastructure (i.e., a multipurpose tower with more than one simultaneous application, such as a wireless communication antenna and solar power receiver) can be used to build central receiver solar power systems. Previous solar tower concepts required stronger towers to hold a heavier or larger receiver and much larger land area to house the mirror field. The use of existing tower infrastructure may combine multiple uses of energy and communications that allow power production costs to be lowered.

In traditional systems, waste heat from a PV receiver may be a problem. A high efficiency cooling (thermal control) system may be integrated to remove this waste heat. Thus, a multi-purpose structure that may include a solar power system and a system with some other purpose, may also include a thermal control system. For example, a wind tower may also include a CPV receiver as well as a thermal control system. The thermal control system may have a gravity fed water tank mounted on the wind tower. The thermal control system may circulate water or another fluid to cool a PV receiver. Since such a wind/solar plant could be located in areas with high wind, the receiver may be small and may have a low wind profile. The receiver may have a shutter that can be quickly closed in emergency or closed as needed to shield the PV receiver from environmental degradation when not in use. The shutter may be made of any material, such as a ceramic or metal material.

A. Retrofitting Structures

One embodiment of the invention provides a method of retro-fitting existing towers with one or more solar receivers. For instance, a structure selection method may be implemented where a structure may be evaluated for how beneficial or cost-effective the addition of one or more solar receivers and/or one or more mirrors may be. Such a method may include evaluating the use of the tower, the height and/or configuration of the tower, the surrounding area, the surrounding structures, the sun exposure, electricity costs, and any other factors that may assist with evaluating an energy and/or cost-benefit to adding a receiver and/or mirrors. For instance, a wind farm may be a desirable location because receivers may be incorporated into windmill towers, and wind farms typically have open areas surrounding the windmills that may provide a desirable location for a mirror field.

If a structure or tower is determined to benefit from the addition of a solar collection system, it may be evaluated to determine one or more beneficial locations on the structure to place a solar receiver. Such beneficial locations may take into account pre-existing purposes for the structure or tower, so as to not interfere with the pre-existing purpose. In some instances, beneficial locations for one or more receiver may be determined in such a way to supplement or augment the pre-existing purpose. Once one or more desired locations on a pre-existing structure or tower is selected, a solar receiver may be attached or retrofitted at the desired location. Preferably, a solar receiver may be attached to an exterior surface of the structure. A solar receiver may be attached to a wall or supporting portion of the structure. Similarly, mirrors may be placed at corresponding desired locations to direct sunlight to one or more added receiver.

A solar receiver may be attached to a structure by any mechanical means known in the art. For example, if a structure is being retrofitted with a receiver, the receiver may be bolted to the side or top of a structure. Alternatively, a receiver may also be attached by any other fasteners such as screws, nails, clamps, or some form of interlocking structure, such as lock and groove features, or any form of adhesive. In some embodiments, a receiver may be attached to a receiver support or armature that may be attached to the structure. The receiver support may place a receiver at a desired location and/or orientation. For example, a receiver support may allow a receiver to protrude from a structure and point slightly downwards.

A solar receiver may also be attached to a structure, such as a wind tower in a way to deal with vibrations that may occur on the structure. For example, a wind tower may experience vibration due to the wind and the motion of the wind turbine blades. Generally, tower motions may be small and may be acceptable for the solar tracking system. However, if a receiver moves a great deal and at a rapid pace, the receiver may move out of the focal spot of the heliostats. If the motion of the tower becomes too large, a receiver may be attached to the tower using a passive vibration dampening mechanism. In situations where passive damping may not be sufficient, the receiver may be attached to the tower with active vibration control to remove the impact of tower motion.

With presently available sensors and actuators, it would be relatively inexpensive to provide passive or active damping. An accelerometer or other motion sensor could be mounted on the tower and another could be mounted on the receiver to measure motion. Active vibration control actuators could be used to counteract the motion of the tower. For example, the actuators to counteract vibration could be as simple as automotive shock absorbers or some of the newer magneto-rheological based shocks. Such parts may be cheap and readily available and the vibration frequency of the tower could be very low so it is easy to counteract.

The attachment mechanism of a solar receiver may enable the solar receiver to be attached to a structure in a fixed manner so that it may remain substantially stationary with respect to the structure. Alternatively, the attachment mechanism may enable the solar receiver to be able to move with respect to the structure. For instance, the attachment mechanism may allow the solar receiver to tilt along one axis of rotation, or to tilt along two or more axes of rotation. In some embodiments, the motion of the solar receiver may be controllable, such that throughout the day or the year, the solar receiver may be moved slightly to receive a desired amount of sunlight reflected off of heliostats. In some embodiments, the system may be configured such that a receiver may mostly receive reflected light for part of the time, and may mostly receive direct sunlight part of the time. In such cases, the orientation of the solar receiver may be manually adjusted, or may be adjusted by control and actuation mechanisms, as is known in the art. For example, the orientation of the solar receiver may be adjusted through a type of ball and socket joint, or by movement about one or more axis, which may occur by using an actuation means, such as a motor. In some instances, a receiver may be mounted so that it may rotate around the tower and “see” or face different parts of the solar field at different times of the day if desired. The receiver may also be mounted in such a way the height of the receiver along the tower may be moved if desired. A receiver may be mounted in a type of track that may allow a receiver to slide along the surface of the tower as desired. In some embodiments, the receivers may be attached to a structure such that it is integrated into the structure itself. This may occur in cases where new multi-purpose structures are built.

A solar receiver may comprise a solar module, a cooling manifold, and electrical connections. A solar module may include a plurality of solar cells. In some embodiments, a solar module may also include optics. In some cases, a solar receiver may be about one square meter in area. A solar receiver may comprise a plurality of tiles (which may be referenced to in some instances as subcells). In some embodiments, a solar receiver may comprise approximately 50 tiles, 20-40 tiles, 40-60 tiles, 60-100 tiles, 100-400 tiles, or may comprise any number of tiles. In some cases, a tile may be approximately five inches by five inches in area, and about 2-3 inches thick. Dimensions for receivers and tiles may vary.

FIG. 2 shows an example of a tile in accordance with one embodiment of the invention. A tile may comprise optics 201, a plurality of solar cells 202, and a cooling plate 203. In some embodiments, the optics 201 may be secondary optics. Secondary optics may have a configuration that may create alleys that may make cooling plate design and/or electrical routing and component placement easier. A receiver may have an additional primary optic. In some embodiments, tiles may comprise a portion of a cooling plate; for example, a receiver may have one cooling plate, and all of the tiles may include optics, solar cells, and the portion of the cooling plate that the solar cells of the tile are contacting. In such a situation, one cooling plate may cool the entire receiver, including all of the solar cells of the various tiles and groups of tiles. In another embodiment, each tile may have its own cooling plate. Multiple cooling plates may be connected to a cooling manifold directly, or may be connected to one another. In some embodiments, a receiver may have a plurality of cooling plates, but tiles may share cooling plates.

Tiles may be connected to a water or other fluid distribution manifold that may assist with cooling, and may be attached to a backing manifold, which may be made of metal. Tiles may include any number of solar cells. For example, a tile may include 50-100 solar cells. Solar cells may have any dimension. In some embodiments, solar cells may be approximately 1 square centimeter.

A solar receiver may be configured on a pre-existing tower or structure in any way that may enable mirrors to direct sunlight to the receiver. A tower or structure may have one or more receivers on it. In some instances, it may be preferable to have multiple receivers oriented at different angles or sides of the structure. This may be beneficial in cases where mirrors may surround a tower, and a first portion of a mirror field may concentrate sunlight on one receiver on the same side of the structure as the first portion of the mirror field, and a second portion of the mirror field may concentrate sunlight on another receiver on another side of the structure, that is on the same side as the second portion of the mirror field. A receiver may be located at the top of a tower or may be located at any height along the tower. Although a receiver may have any orientation or location, it may be preferable for the receiver to be oriented so that the receiver face may be facing substantially horizontally or at a slight downward angle. A receiver may lie more or less flat against the side of a structure. One or more mirrors may direct sunlight to one or more receivers located on the pre-existing structure. A receiver may be oriented to be approximately perpendicular to one or more mirrors directing sunlight to it.

The pre-existing structure may include other features for other uses that may be taken into account for placement of receivers. For example, if the pre-existing structure is a windmill tower, the receivers may be placed such that they are usually not obscured by a windmill blade. Systems and methods for shadowing accommodations are discussed in greater detail below. If the pre-existing structure is a cellphone antenna tower, or any other similar wireless communication tower, a receiver may be placed in such a way so as to not interfere with an antenna. If a preexisting structure is a building or high-rise, the solar receiver may be placed so that it does not block sunlight to a window, or so that it is on a side of a building that receives a greater amount of sunlight. Thus, pre-existing towers or structures can be retrofitted with receivers such that they work with the multiple purposes of the tower.

In some cases, solar receivers may assist with performing the other purposes of a multi-purpose tower. For instance, a solar receiver system retrofitted to the tower may provide some or all of the electricity for the tower to perform its other function. For instance, electricity from a solar receiver system may supplement the power used to power a cellphone antenna tower. Or the solar receiver may be a thermal receiver that may provide heat or heated water to a building that it is attached to.

B. Multiple Receivers

The tracking methods outlined in this document may enable the use of multiple receivers to be used with dynamic control of the mirror field to redirect sunlight to the desired receiver. The multiple receivers may be located on a single tower (the receivers may be in any orientation, height, or direction on the tower for optimum performance) or on separate towers. The receivers may be photovoltaic, thermal, or of other types, or combinations thereof. For instance, one or more of the receivers may be a photovoltaic receiver and one or more of the receivers may be a thermal receiver.

The mirror field may be computer controlled to allow sunlight to be directed to the desired receiver. This may allow solar power to be directed to different applications as needed—e.g., solar photovoltaic, solar thermal for immediate electric power generation, solar thermal energy storage, hot water, steam production, process heat, chemical processing/reforming, solar hydrogen production, solar absorption or adsorption cooling systems, solar energy liquid fuel production, etc. This dynamic control can allow all light to be directed to a single application or some fraction of light to each desired application. Mirrors may focus more or less of the solar energy on various types of receivers in accordance with another purpose of a multi-purpose structure. For example, if the multi-purpose structure requires a greater electricity input for a particular function, mirrors may focus more sunlight to a photovoltaic receiver. If, for a given moment, a multi-purpose structure requires more solar thermal input, mirrors may correspondingly focus more sunlight to a thermal receiver.

Depending on the time of day or time of year, it may also be beneficial to change the receiver that a particular mirror is concentrating on. For instance, in the morning, a greater portion of a field of mirrors may focus sunlight onto one receiver on one side of a pre-existing tower or structure, while in the afternoon, a greater portion of a field of mirrors may focus sunlight onto another receiver arranged at a different angle or side of the pre-existing tower or structure. Similarly, in the winter, more mirrors may focus sunlight onto a solar thermal receiver than during the summer to provide a desired amount of heat. Also, depending on another use of the multi-purpose structure, a portion or all of the field of mirrors may modify or control which receiver the mirrors are focused on. For instance, if a use of the multi-purpose structure causes a portion or all of the structure to move in some way, the mirrors may focus on another receiver that is at a better angle. For example, if a tower structure were to rotate, a receiver connected to the structure may rotate with it, which may cause another receiver to come into a better angle for one or more surrounding mirrors.

C. Shadow Accommodation

One aspect of the invention provides systems and methods to accommodate shadows that may arise in a central receiver solar power system. Traditional solar electric power generation systems may rely on sunlight impinging upon a photovoltaic (PV) panel to convert light to electricity (e.g., traditional silicon solar panels). In some embodiments, a solar panel may be approximately one square meter in area and may be placed in a regular grid pattern on support structures (the support structures may also allow the receivers to track the motion of the sun). A solar panel may comprise a plurality of solar cells. Solar panels may be electrically connected in series to make a string of panels. Many such strings are arranged to form an array. One key problem with current solar PV technology is that shadows cast by nearby objects can obscure sunlight that would have landed on a solar panel, which may cause a ‘blacks spot’ in the series string, which may impair the performance of an entire solar array. However, the impact of shadows on the performance of a solar PV power system may be reduced as described below.

A particular area of interest for solar power deployment may be in locations where existing tall structures exist that may cast shadows on the solar panel array. One such location may be in the proximity of windmill towers or in arrays of windmills known as wind farms. Typical wind farms may have large areas of land between towers that are approximately 50 to 100 meters tall. Windmill blades may have diameters greater than 70 meters across. Any discussion of wind farms herein may be applied to any shadow-inducing structures or elements. One skilled in the art may apply discussion of wind farms to any structure.

The shadow of a windmill may have two components, each of which is time varying—a) the shadow of the tower and nacelle that can vary in position with the motion of the sun during the course of the day and the year; and b) the shadow of the windmill blades that may move with the motion of the wind (typical blade rotation speeds for large turbines can be in the range of approximately 10 revolutions per minute or faster). Thus the two shadow components can create time varying shadows that may move quickly (blades) and slowly (tower shadow over course of day). An array of solar panels including solar cells built near and around the base of a windmill tower may experience the negative effects of both of these shadows. The quickly varying blade shadow may effectively cause a power ripple to be generated by a panel or group of panels at the rotation speed of the windmill blades. Since standard solar power modules and power electronics may be designed to operate under DC power conditions, the variable AC power generated by the moving blade shadow may effectively impede the functioning of the solar power system. One solution to this problem may be as follows.

Instead of one or more solar panels being mounted around the windmill tower at ground level, the invention provides mounting an array of mirrors on sun tracking mechanical fixtures (heliostats) near the base of the tower. This array of heliostats may be designed to track the motion of the sun such that the reflected light from each heliostat can be directed to a common focal point that is located at some elevation above ground level. This common focal point may be located at a spot on the windmill tower or may be on another nearby existing tower or specially constructed tower. The light reflected from every heliostat in the array may be focused to this central point. At this central point, a solar energy conversion device may be mounted that may work by PV conversion or thermal conversion (e.g., water to steam).

The heliostat array may cover any area of land surrounding the structure with the solar energy conversion device. For instance, the heliostat array may cover hundreds to many thousands of square meters of land area. In this configuration, the concentrated sunlight received at the focal point may be the spatial summation of all the light hitting all the mirrors in the heliostat array. One can design the spatial extent of the heliostat array such that the shadow of the tower may fall within the solar field such that the spatial intensity of light may be nearly constant over relatively short time periods across the entire area of the solar field. For example, the shadow area of the tower across the solar field may be a constant area. Or similarly, the number of heliostats covered by a shadow at a given moment may be nearly constant. For example, an algorithm may be used to design a solar field, such that a shadow of a structure at any given time may be predicted and heliostats may be placed such that at any given moment, the substantially same number of heliostats may fall under the shadow. The heliostat array field may be larger than the area covered by the shadow.

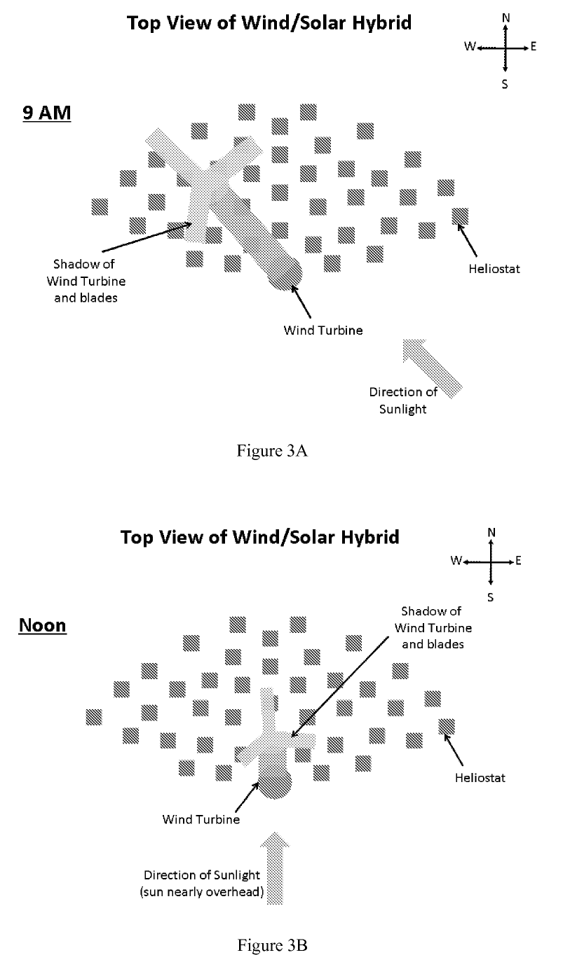

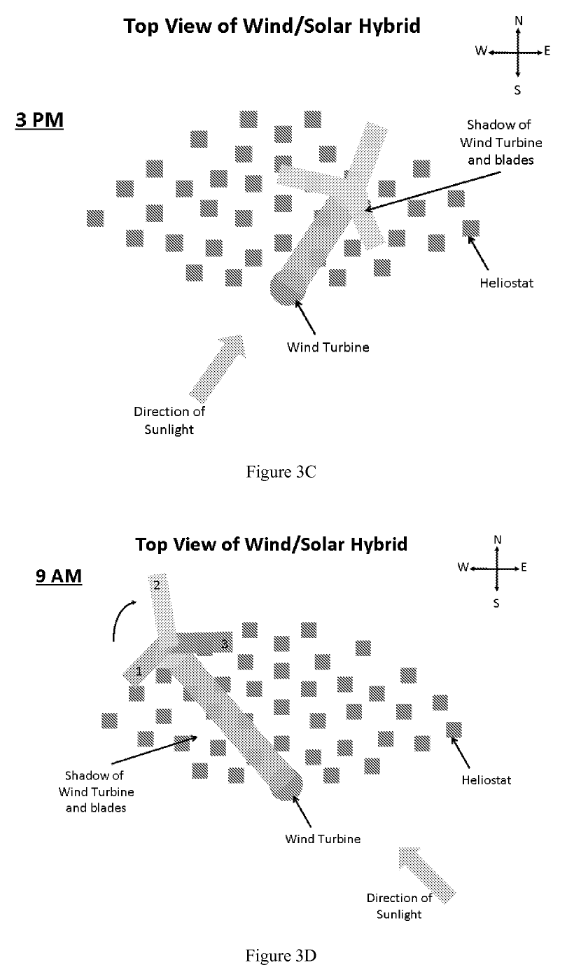

FIG. 3A shows a top view of a structure along with a field of heliostats at a first time. For instance, the first time may be at 9:00 AM. The structure may be a wind turbine combined with a solar receiver. The shadow of the wind turbine may face away from the direction of sunlight. The field of heliostats may be larger than the shadow of the wind turbine and blades, as is shown.

FIG. 3B shows a top view of a structure along with a field of heliostats at a second time. For instance, the second time may be at 12:00 noon. The structure may be a wind turbine combined with a solar receiver. The shadow of the wind turbine may face away from the direction of sunlight. Since the sun is nearly overhead at noon, the shadow may be smaller than it was at 9:00 AM. This may vary with latitude and season. The field of heliostats may be larger than the shadow of the wind turbine and blades, as is shown. Since the sun moves slowly, this may enable the illumination on the receiver to be near constant over a short period of time. In some embodiments, the density of the heliostats may be arranged such that nearly the same number of heliostats may be under the shadow at a given moment.

FIG. 3C shows a top view of a structure along with a field of heliostats at a third time. For instance, the third time may be at 3:00 PM. The structure may be a wind turbine combined with a solar receiver. The shadow of the wind turbine may face away from the direction of sunlight, which may have moved such that the shadow substantially falls northeast. The field of heliostats may be larger than the shadow of the wind turbine and blades, as is shown. Thus, over the period of a day, the field of heliostats may be arranged such that it is always larger than the shadow of the wind turbine and blades.

The spatial extent of the heliostat array may also be designed such that the shadow of the windmill blades may cover a nearly constant area across the solar field in a time scale consistent with the blade rotation speed. For example, the shadow of one blade of the windmill may fall upon the solar field such that as it rotates, its shadow may not hit the solar field but the shadow of another blade may impinge on the solar field. If the new shadow appears on the solar at approximately the time the other shadow leaves the solar field, the spatially summed power ‘seen’ by the receiver may be constant. The heliostat array field may be larger than the projection of the shadow of the windmill and blades, or any other structure and any moving parts associated with the structure.

FIG. 3D shows a top view of a structure with a moving part along with a field of heliostats. In one example, the top view may be provided at 9:00 AM. The structure may be a wind turbine combined with a solar receiver. The shadow of the wind turbine may face away from the direction of sunlight. A wind turbine may include three blades, which may case shadows as indicated by the numbers 1, 2, and 3. As the shadow from one blade (i.e. blade 1) enters the heliostat field, the shadow from another blade (i.e. blade 3) may leave the heliostat field, such that at any given moment, the shadow from about one blade can cover a heliostat field. The sum of all heliostat reflections may stay substantially constant even with rapid time varying blade shadow. Thus, the spatial sum of the light from the heliostat field may be more or less constant.

The invention provides specific design and implementation of a solar collection system that may be immune to the negative impact of shadows. The array of heliostats surrounding a solar receiver may be designed to allow improved efficiency by minimizing detrimental factors, such as shadow effects. The size of the land surrounding the heliostat array may be a factor in the design, as well as individual placement of the heliostats. This may allow solar energy to be integrated in locations with existing tall infrastructure such as wind farms. By engineering the solar collection system in this manner, the system may leverage much of the infrastructure of a wind farm or other structures to lower cost and speed construction of solar power systems.

II. Tracking Systems and Methods

One aspect of the invention provides for accurate methods for heliostats to track and direct sunlight. One possible application for accurate tracking is that it may enable smaller receivers to be used, which may allow greater flexibility for solar tower integration with other structures. Typically, measuring and controlling an array of mirrors for best spot size has been a difficult and costly process. This invention provides systems and methods to simplify this tracking and control process with low cost parts, which may thus enable widespread use of heliostat based solar power systems. This invention consists of multiple unique systems or methods that may be used individually or in various combinations to optimize field performance.

A. Accelerometer

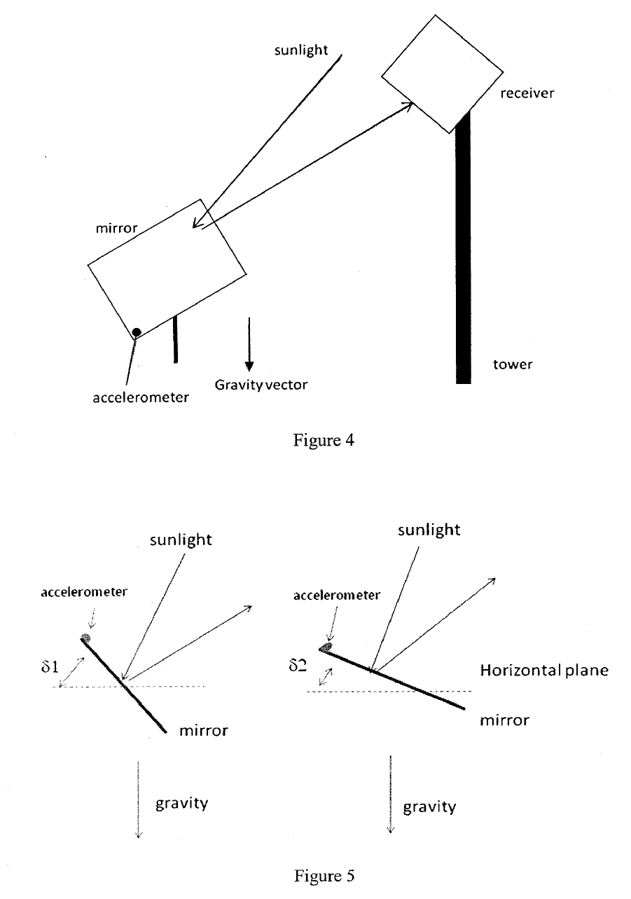

Accelerometers may be combined with heliostats in accordance with one aspect of the invention. Heliostats with accelerometers may be integrated into any of the systems described. FIG. 4 shows sunlight reflecting from a mirror and directed to a receiver on a tower. A receiver may be a photovoltaic (PV) receiver, such as a concentrated photovoltaic (CPV) receiver, or a thermal receiver, or any other type of receiver. An accelerometer may be mounted on the mirror assembly of the heliostat to measure mirror tilt. Although FIG. 4 shows only one mirror, a heliostat field may comprise any number of such mirror assemblies. In some embodiments, the mirrors may all reflect light to a central tower. Any number of mirrors may include an accelerometer. In some embodiments, every mirror may include an accelerometer.

Accelerometers may be micro-electromechanical systems (MEMS) devices. Accelerometers have been used in automotive airbags to measure the change in acceleration of a vehicle to trigger release of the airbag. They are made in very large volume and are now available at very low cost. Thus, the use of accelerometers to measure mirror tilt may result in a low-cost tracking method. Traditionally, accelerometers have been used in situations with motion. See e.g., U.S. Patent Application No. 2008/0011288, which is incorporated by reference herein in its entirety. For instance, accelerometers have been used to measure large g-forces where a trigger mechanism is required and not for precision measurements on a continuous basis used for feedback control. However, the invention provides situations in which accelerometers may be used in substantially static conditions.

Accelerometers may measure a force vector, and under static conditions may measure the force vector of earth's gravity. FIG. 5 shows an accelerometer mounted on a mirror with two different mirror tilt angles. In this case, a two-axis accelerometer may measures two components of the gravity force vector due to the tilt of the mirror. For instance, a two-axis accelerometer may measure two components of the gravity force vector and may be compared with the known magnitude and orientation of the gravity vector, to determine the angle of mirror tilt, such as δ1 and δ2. Sunlight may be reflected from the mirror, such that the incident angle equals the reflected angle. Under static conditions, accelerometers may be able to determine precise measurements, such that placing accelerometers on a mirror of a heliostat mirror field may enable measurement of the precise tilt of the mirror. The accurate measurement of the mirror tilt allows the precise determination of the direction of reflected sunlight from the mirror.

Any type of accelerometer known in the art may be used in accordance with the invention. For example, a three-axis accelerometer may be used, which may be directed to three orthogonal axes. Alternatively, individual one-axis accelerometers may be mounted in thee orthogonal axes. Any combination of accelerometers may be used, including a two-axis accelerometer in combination with a one-axis accelerometer. Accelerometers may be mounted in such a way to collectively measure force in three orthogonal axes. This may allow full measurement of a gravity force vector. In some embodiments, the three orthogonal axes may be oriented to correspond to the length, width, and height of the mirror. Alternatively, accelerometers may be mounted to collectively measure force in any number of axes that may have any orientation. Calculations may be made to accommodate any accelerometer axis orientation.

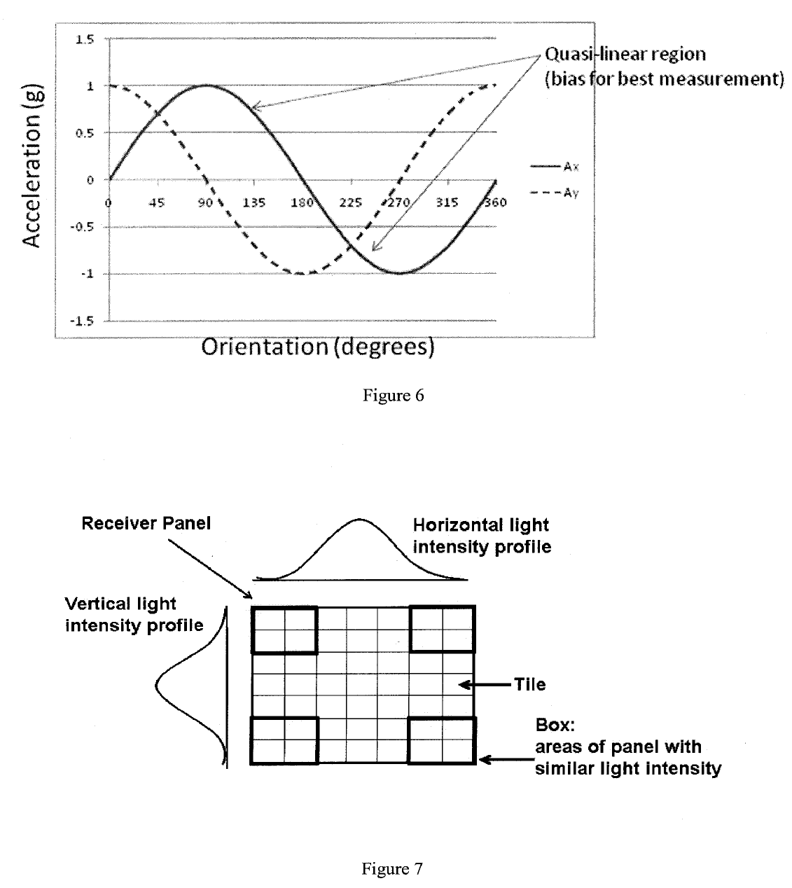

FIG. 6 shows a typical response of an accelerometer to change in orientation angle. Accelerometers may be mounted in such a manner that the force vector is properly biased to be along the quasi-linear portion of the sinusoidal response curve of the accelerometer with respect to tilt curve. This may enable improved measurement accuracy. Multiple-axis accelerometers may be mounted so that each axis is biased in the quasi linear region.

An accelerometer may be affixed to any portion of the mirror. In some embodiments, it may be preferable to place an accelerometer on a corner of a mirror. Alternatively, an accelerometer may be placed at the center of a mirror or at any place on the surface of a mirror In other embodiments, an accelerometer may be placed on any structure designed to move with mirror tilt (i.e., a structure supporting the mirror that causes the mirror to move, such as a backing). In preferable embodiments of the invention, a mirror may be flat. In other embodiments, a mirror may have a curved surface. An accelerometer may be placed on any portion of the curved mirror surface.

Heliostat mirror fields can cover large areas. For instance, heliostat mirror fields may cover many hundreds of meters in length and width. A required pointing accuracy may increase as the distance from an individual mirror to a tower increases. This angular tracking accuracy requirement can be less than 0.1 degrees as field size increases. A properly calibrated accelerometer can measure to this level of measurement accuracy.

The heliostat mirror with one or more accelerometers can be calibrated at the factory or at field installation such that an accelerometer force vector may relate to a specific tilt of the mirror. In some embodiments, the relationship between an accelerometer force vector's and a mirror tilt may be stored in a look-up table or similar database storage. In such a manner, for a given accelerometer reading, the corresponding minor tilt may be looked up. In some embodiments, a processor and algorithm may be provided to calculate the mirror tilt in relation to an accelerometer's force vector measurement, with respect to the calibration reference point. Such memory for look-up tables or to store reference data, and processors to conduct any calculations or determine mirror tilt, may be part of a heliostat. Each heliostat may have its own memory and processor to determine mirror tilt. Alternatively, each heliostat may be in communication with a central controller that may include a memory and processor that may be capable of determining the mirror tilt angle for each heliostat.

By combining this information of mirror tilt with the precise position of the sun as a function of date, time, and location of mirror, it is possible to know where the reflected beam should point. In one embodiment of the invention, during an initial setup and calibration procedure, the relationship between a mirror and a solar receiver may be determined. For example, the mirror may be directed to reflect the sunlight to the receiver at a known time and date, and the tilt angle of the mirror to successfully reflect the sunlight to the desired spot on the receiver may be measured. The measurement may be an accelerometer measurement. Based off the known sun position at a given date, time, and location, and given the mirror tilt (or accelerometer measurement), the receiver location with respect to the mirror may be determined. Thus, desired mirror tilts at given times and dates to reflect sunlight to the receiver can be determined. The heliostat may control the mirror position to get it into the desired orientation, so that it may reflect sunlight to the receiver throughout the day.

In an alternate embodiment of the invention, a solar receiver may emit some sort of signal that may assist with determining the location of the solar receiver. For example, the solar receiver may have a transmitter located at the center of the receiver or near the receiver. A heliostat may be able to receive the signal transmitted by the receiver, and determine the relative position of the solar receiver. Based off the known sun position at a given date, time, and location, as well as the relative position of the solar receiver, the desired mirror tilt at given times and dates can be determined. In yet another embodiment of the invention, the relative position between the mirror and solar receiver may be manually entered or may be delivered to the heliostat through a network.

The controls for each heliostat may be built-into the heliostat itself. For example, a heliostat may include electronics that may enable it to determine how to move the mirror and may include electronics that enable it to control the actuation mechanisms that may get the mirror into the desired position. Such control electronics may be localized at a control box of a heliostat. Each heliostat may be capable of independently determining the desired mirror tilt and controlling the mirror position accordingly. Any mirror control mechanism known in the art may be used. Such mirror control mechanisms may comprise any actuation means, which may include but are not limited to servo motors, electric motors with gears, hydraulic or pneumatic systems, counterweights, solenoids, springs, or any other mechanism. In some embodiments, each heliostat may be equipped with small local power production capability. For example, each heliostat may have a small conventional solar panel and/or small battery. This may allow easier and lower cost installation by eliminating or reducing need for wiring for the heliostat field.

In some embodiments, a central control system may be in communication with one or more of the heliostats. In some embodiments, the central control system may be in communication with each heliostat. The central control system may be on a server that may be in communication with the heliostats over a network. In some embodiments, the network may be a local area network, or a wide area network, or the Internet. The heliostats may be physically connected to one another, to the central control system, or to a network through a wire, or may communicate wirelessly.

A central control system may determine the desired tilt of each mirror and may communicate with individual heliostats to cause heliostats to place their mirrors at the desired orientation. A central control system may incorporate other sensors or devices to determine desired mirror tilt. For example, a central control system may communicate with a temperature sensor at a receiver. The central control system may determine when a receiver is overheating, and may cause fewer mirrors to direct sunlight to the receiver if it is starting to get too hot. In situations with multiple receivers, the central control system may determine desired arrangements such that a first group of mirrors may focus light to a first receiver, and a second group of mirrors may focus light to a second receiver, or how mirrors may change their focus from one receiver to another.

A user may be able to interact with a central control system. For example, a user may access a central control system and control or monitor the conditions relating to the heliostats. In some embodiments, a user may access a central control system through a user interface, which may be provided by a computer, PDA, phone, laptop, or any other network device. In some embodiments, the user interface may be integrated with a structure that may be part of a heliostat or tower, or any other apparatus associated with the solar power system. A user may interact with the central control system to monitor conditions and/or intervene with the current control scheme. A user may also be notified of certain error or alarm conditions, and certain apparatus may be placed at default settings until the user intervenes.

B. Current Balancing

The focused spot on a receiver consists of the incoherent sum of the spots from all the mirrors in a heliostat field. In some embodiments, this may be hundreds or thousands of mirrors. As the sun moves, the reflected spots from the mirrors may move across the surface of the receiver. The pointing and tracking algorithms controlling the mirrors may be designed to compensate for the sun's motion and may keep the reflected spot from each mirror focused at the center of the receiver.

FIG. 7 shows an example of a receiver panel with an array of tiles and a cross sectional intensity pattern. The lighter shading on the receiver panel may correspond to greater light intensity. As previously discussed, it may be desirable to have the greatest illumination at the center of the receiver. In some embodiments, the light intensity profiles may have a bell-shaped curve as indicated in the figure. Depending on how the aggregation of reflection from the mirrors hit the receiver, the light intensity profiles may vary. Some portions of the receiver may have areas of similar light intensity. For instance, boxes in the figure may indicate areas of the receiver with similar light intensity. The areas of similar intensities, such as those denoted by the boxes at the corners, may comprise groups of tiles, which also may be referred to as a subarray of the receiver. For example, FIG. 7 shows an array of 7×7 tiles. The boxes in the corners show groupings of four tiles teach, such that each subarray is 2×2 tiles. If the light is focused at the center of the receiver, the corners may have similar light intensities. Thus, the subarrays at the corners may have similar light intensities.

Areas of similar intensity levels maybe connected in series so that a generated photocurrent is matched. As discussed, a receiver may comprise a plurality of tiles. The tiles may be arranged as an array. A group of tiles may form a subarray. Any number of tiles may be provided, although in some embodiments, 40-60, 60-100, 100-200, 200-500 tiles may be assembled to form a receiver. For example, 400 tiles of 5 cm×5 cm may be assembled into a receiver of size 1 m×1 m. In some embodiments, the receiver may comprise a photovoltaic solar module.

These tiles or subarrays may be electrically connected in parallel or series in various configurations. Solar elements may be electrically connected in any way known in the art. See e.g., U.S. Pat. No. 6,686,533 and U.S. Pat. No. 5,851,309, which are herein incorporated by reference in their entirety. One preferable embodiment of the invention provides a method connecting areas of a receiver that are likely to have similar illumination levels such that the photocurrent from tiles or groups of tiles are matched. The example provided in FIG. 7 below shows an ideal case of a bell shaped intensity profile incident on the receiver panel. Since the corner sections of the panel receive lower illumination (and the lower generated photocurrent), the tiles in these corners may be connected in series since their photocurrents may be nearly matched. Similarly subarrays in the corners may be connected in series since their photocurrent may be nearly matched. Likewise, other portions of the receiver with nearly equal photocurrent may be matched and connected in series. For instance, tiles or groups of tiles toward the center of the receiver may be connected in series. In some embodiments, the tiles or groups of tiles connected in series may have similar photocurrents as other strings of tiles or groups of tiles connected in series. In some cases, a greater number of tiles or groups of tiles that receive lower illumination may be connected in a series string, and a lesser number of tiles or groups of tiles that receive higher illumination may be connected in a series string. Various series strings of tiles or groups of tiles may be connected in parallel. The connection of tiles or groups of tiles in this manner may lead to improved electric power extraction efficiency. Any discussion of connections of tiles herein may also apply to groups of tiles (subarrays).

In a preferable embodiment of the invention, about 10 to 100 strings of serially connected tiles may be connected in parallel. Each string may contain tiles or subarrays with similar expected levels of illumination. Such tiles or subarrays with similar levels of illumination may generate similar photocurrents. For example, a string of tiles or subarrays may contain tiles from the corners of the receiver, another string may connect tiles or subarrays from the sides of the receiver not by the corners, another string of tiles or subarrays may connect tiles from the center of the receiver. Such series connected cells may have a roughly annular shape corresponding to illumination levels when the greatest illumination is at the center of the receiver.

In alternate embodiments, serial string of tiles may include tiles with photocurrents that may not be matched. The individual tiles may not necessarily be in a series connection with tiles of the same illumination level. For example, a serial string of tiles may correspond to a particular region of a receiver, and the number of tiles may vary. In another embodiment, the tiles with a serial string may have the same illumination level, and such strings may or may not be connected in parallel.

C. Illumination Centering

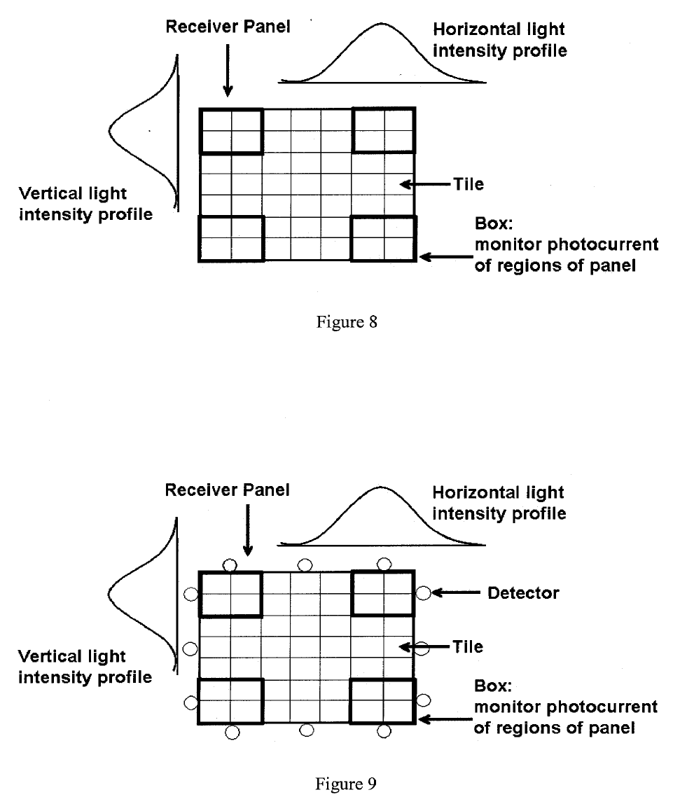

Photocurrent generated from different spatial areas of the receiver may be monitored to determine the tracking accuracy of mirrors in the heliostat field. The field incident on the receiver may be the superposition of light reflected from many mirrors. FIG. 8 shows a receiver with an array of tiles and a cross sectional light intensity pattern. In this case, the light distribution is off center and may be corrected for improved performance. FIG. 7 shows a preferable light distribution, where the greatest illumination is directed toward the center of the receiver. In other embodiments, a desired light distribution may be an even distribution of light across a receiver. A desired light distribution may be defined for a given situation. The generated photocurrent from the four box areas denoting the corners may differ when the light distribution is off center and an error signal can be generated from this difference.

Although the figure shows a rectangular ray of tiles, a receiver may have any shape. For example, a receiver may have a roughly circular shape, with rectangular or other shaped tiles. Thus, the term “corner” is used loosely herein and may refer to outer portions of a shape that may be relatively far apart from one another. For example, four corners of a circle may refer to four points along the perimeter of the circle that are equidistant from one another. In another example, a triangularly shaped receiver may have three corners.

The light distribution for a solar receiver may be determined in any number of ways. For example, a plurality of detectors may be used to indicate a relative illumination level for a tile or group of tiles. Any type of detector may be used, including but not limited to the following.

In some embodiments, the detector may be a photo-detector may be used to monitor light intensity for a tile or subarray. Any discussion of detecting illumination or photocurrent for a tile may also apply to detecting illumination or photocurrent for a subarray. For instance, a photo-detector may be placed at each corner of a receiver. The difference in any of the four corners may be monitored. If the light distribution is out of balance, an error signal may be generated. In some embodiments, a photo-detector may be used to determine light distribution at any tile on a receiver. For example, each tile or group of tiles may have a photo-detector, and the light distribution across the receiver may be determined. In some embodiments, several key tiles, such as the corners may have a photo-detector. This may monitor light intensity at given points, which may be sufficient to determine whether a desirable light distribution is occurring. Placing photo-detectors at the corner tiles or subarrays, or at other tiles or subarrays on the receiver (i.e. along the diagonals of the receiver) may be sufficient to determine whether the aggregated light focus is off center or not. A greater number of photo-detectors may be utilized if a particular light distribution is required, and greater accuracy is helpful.

In some embodiments, the detectors may monitor the photocurrent generated by a given tile or group of tiles. The illumination level on each tile or group of tiles may be determined by measuring the photocurrent from the tile or group of tiles (thus treating each tile or group of tiles as if it were a single photo-detector). In some embodiments, the variation in tile photocurrent from one tile or group of tiles to another may be used to determine an error signal. In this case, additional photodiodes may not be necessary to measure spatial light intensity across the receiver.

Alternatively, any other sort of detector that may be used to determine illumination on a tile or group of tiles may be used. For instance, a photodiode or phototransistor may be utilized to determine illumination. Any discussion of photo-detectors may apply to any detector that can be used to determine illumination, including any detector that may measure current generated by a tile.

Additionally, as shown in FIG. 9, detectors may include extra optical detectors, which may be placed around a receiver to detect light intensity. An array of low cost optical detectors may be placed around the perimeter of the receiver. These optical detectors may be placed in any location about the receiver panel. For example, four optical detectors may be placed at the corners of the panel. In some embodiments, the optical detectors may be placed within the receiver so that they are not at the perimeter of the receiver. Such optical detectors may detect optical signals from any portion of the receiver. These optical detectors may be fiber coupled with only fiber optic cables interfaced to the periphery of the receiver panel. Fiber cable may have a higher damage threshold and may be able to withstand the fluence at the receiver and the detectors themselves can be remotely placed. High light intensity measured by detectors at the perimeter of a receiver may indicate mirror misalignment that can be corrected with feedback signal. Optical detectors may be used in conjunction with other detectors or in the place of photo-detectors or current detectors.

As discussed previously, whenever the determined light distribution falls outside of an acceptable range, an error signal may be generated. In a preferable embodiment, an error signal may be generated when the difference between the currents generated by tiles placed at the four corners of a receiver exceeds a preset amount. The differential photocurrents generated by different areas of the panel may also refer to photocurrents generated by groups of tiles, such as a group of four tiles in a corner, as illustrated by the corner boxes in FIG. 8. This may indicate that the light distribution is off center. In another example, an error signal may be generated when the current generated by tiles or subarrays placed at a corner or along a perimeter of a receiver exceeds the current generated at the center of a receiver.

The error signal can be used to feedback to mirror controls and actuators. For a single mirror, it may be simple to determine how the mirror should be moved in order to remove the error and provide a desired light distribution. However, in many cases, there may be many mirrors, and the light distribution may be a superposition of many reflected spots.

A method of aligning mirrors to create a desired illumination may include temporally staggering the motion of each mirror from all others. For example, only one mirror may be moved at a time and the resultant change in photocurrent from different tiles or areas of the receiver panel may be measured. For instance, a mirror may be moved slightly to see the effect of the resultant change on the receiver. If a mirror had been properly aligned to begin with, it may be moved back to its starting position. In another example, if detectors are placed at the corners of a solar receiver, a mirror may be moved until the detectors indicate that the illumination at the corners is as evenly distributed as possible with the one mirror's adjustments. The movement of a single mirror at a time may allow correlation of the movement of one mirror with the illumination spot location on the receiver. This system can proceed sequentially until all mirrors in the field are aligned. For a field size of 500 mirrors, if each mirror required 10 seconds for motion and error signal determination, the total time for entire field measurement may be less than 10 minutes.

In some embodiments, a plurality of mirrors may be moved in conjunction. For example, two, three, five, or ten mirrors may be moved at a time to determine whether any of the mirrors collectively cause the error. For example, multiple mirrors may be moved in different directions, and the effects on the light distribution may be analyzed. These groupings of mirrors may be tested sequentially, such that a first group of mirrors comprising multiple mirrors is tested, then a second group of mirrors comprising multiple mirrors may be tested.

In some embodiments, depending on the placement of the mirrors, for a given detected error, one or more mirrors may be more suspect for causing the error. In such situations, such suspect mirrors may be tested first. Such suspect mirrors may be individually tested in a staggered order, or in groups. If the suspect mirrors are not the cause of the error, the rest of the mirrors may be tested sequentially, individually or in groups.

Thus, differential measurements from the receiver itself may be used to optimize mirror alignment. Traditional heliostat fields have been made with thermal receivers that may not be monitored for spatial intensity variation. Traditional photovoltaic receivers may be illuminated directly by the sun and not a superposition of beams; thus monitoring of tiles or groups of tiles within the receiver is not done. However, the invention provides systems and methods for monitoring tiles or groups of tiles of a concentrated photovoltaic receiver, which may receive light that is a superposition of beams reflected by mirrors. The invention also provides systems and methods for controlling the mirrors to provide a desired light distribution on the receiver.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A solar-wind tower, comprising:
a wind tower capable of utilizing wind energy to generate power;
a photovoltaic receiver attached to the wind tower; and
at least one heliostat mirror capable of reflecting light from a light source to the photovoltaic receiver.

2. The tower of claim 1 further comprising a plurality of heliostat mirrors, wherein the heliostat mirrors are arranged in an array such that the area of the array exceeds the area of the shadow of the wind tower at any given time.

3. A multi-purpose apparatus, comprising:
a structure with a purpose unrelated to solar or wind energy production;
a solar receiver attached to the structure; and
at least one heliostat mirror capable of reflecting light from a light source to the solar receiver.

4. The apparatus of claim 3 wherein the solar receiver is a photovoltaic receiver or a thermal receiver.

5. The apparatus of claim 3 wherein the structure is at least one of the following: a cellphone tower, a wireless communication tower, an electrical tower, a tall building, a telephone pole, or an antenna tower.

6. A method for utilizing an existing structure for solar power, comprising:
providing a pre-existing structure within a defined area, the pre-existing structure having a purpose unrelated to solar energy production;
retrofitting the pre-existing structure with one or more solar receivers; and
providing at least one heliostat mirror within the defined area, the at least one heliostat mirror capable of reflecting light from a light source to the one or more solar receivers.

7. The method of claim 6 further comprising evaluating the pre-existing structure to determine whether solar energy production would be beneficial or cost-efficient.

8. The method of claim 6 wherein the pre-existing structure is retrofitted with one or more solar receivers by mechanically attaching the one or more solar receivers to the structure exterior.

9. The method of claim 6 wherein the defined area is permitted for renewable energy use.

10. A solar tracking apparatus, comprising:
a mirror for reflecting incident solar radiation;
a base that supports the mirror, and allows motion of the mirror about at least one axis;
an accelerometer for generating signals representative of the mirror's orientation with respect to a gravity vector;
a control system to determine a desired mirror orientation based on the signals generated by the accelerometer, a predicted location of the sun, and a location of a desired focal point; and
an actuator for driving the mirror to the desired orientation.

11. The apparatus of claim 10 wherein the accelerometer includes at least one of the following: a MEMS accelerometer, a three-axis accelerometer, or a plurality of one-axis accelerometers.

12. The apparatus of claim 10 wherein the accelerometer is affixed to the mirror.

13. A method for creating a desired light distribution on a solar receiver, comprising:
providing a solar receiver comprising:
a plurality of PV tiles; and
a plurality of detectors that may indicate a relative illumination level for a PV tile or group of PV tiles;
determining whether an error condition exists based on information provided by the plurality of detectors;
adjusting the orientation of a first mirror or group of mirrors reflecting sunlight to the receiver and determining whether the first mirror or group of mirrors is creating the error condition; and
adjusting the orientation of a second mirror or group of mirrors reflecting sunlight to the receiver and determining whether the first mirror or group of mirrors is creating the error condition.

14. The apparatus of claim 13 wherein a plurality of PV tiles with a similar expected illumination levels are electrically connected in series.

15. The apparatus of claim 13 wherein each PV tile comprises an optic, a solar cell, and a cooling plate.
